(19) United States
(12) Patent Application Publication
(10) Pub. No.: US 2005/0048847 A1
(43) Pub. Date: Mar. 3, 2005

(54) Electrical power jack

(76) Inventor: Guang-Rung Hsieh, Shung-ching City (CN)

Correspondence Address: MOLEX INCORPORATED, 2222 WELLINGTON COURT, LISLE, IL, 60532, US

(21) Appl. No.: 10/650,022

(22) Filed: Aug. 27, 2003

(30) Foreign Application Priority Data
Aug. 27, 2002 (TW) 91213361

(51) Int. Cl. H01R 24/04

(52) U.S. Cl. 439/668

(57) ABSTRACT

A power jack includes an insulative housing having an interior cavity and a peripheral passage extending through the housing and communicating with the cavity. A first, center terminal is mounted on the housing and has a contact portion extending into the interior cavity and a mounting portion disposed outside the cavity. A second, peripheral terminal has a body portion and a mounting portion extending at an angle to the body portion. The body portion and the mounting portion are inserted through the peripheral passage into the interior cavity and spaced outwardly of the center terminal. The peripheral terminal includes a spring arm cantilevered from the body portion into the interior cavity and having a first contact portion thereon. An extension arm is cantilevered from the mounting portion into the interior cavity and has a second contact portion thereon.

### FIELD OF THE INVENTION

This invention generally relates to the art of electrical connectors and, particularly, to an electrical power jack.

### BACKGROUND OF THE INVENTION

Various types of electronic apparatus are provided with a power jack adapted to receive power supply from an adapter. For instance, mobile electronic apparatus, such as a notebook computer, a cellular phone, PDA or the like, include a powerjack for charging a storage battery of the apparatus or to directly provide necessary working voltage to the internal circuit of the mobile electronic apparatus.

FIGS. 1 and 2 show a cellular phone, generally designated 10, of the prior art and which includes a number of power jacks 12, 14 and 16. Power jack 12 is provided for connection to a power circuit of a motor vehicle to maintain the cellular phone in a charging status. Powerjack 14 is provided for connection to a battery charger. Power jack 16 is provided for connection to a local power supply through a power adapter, generally designated 18.

Still referring to the prior art apparatus of FIGS. 1 and 2, power jack 16 includes a casing 20 having terminals 22a and 22b mounted therewithin. When a plug 18a of power adapter 18 is inserted into power jack 16, the side and center contacts 18b and 18c, respectively, of the plug are maintained in contact with terminals 22a and 22b, respectively, of power jack 16, providing the desired electrical energy to cellular phone 10.

The above-described prior art power jack 16 requires considerable installation space in the bottom of the cellular phone. In addition, because terminal 22a has only one small contact point 24 engaging side contact 18b of plug 18a of power adapter 18, positive contact engagement cannot be assured and can result in a poor electrical connection. The present invention is directed to providing a power jack which eliminates these disadvantages and/or problems.

### SUMMARY OF THE INVENTION

An object, therefore, of the invention is to provide a new and improved power jack of the character described.

In the exemplary embodiment of the invention, the power jack includes an insulative housing having a front face, a rear face and peripheral side wall means extending between the front and rear faces and forming an interior cavity within the housing. Peripheral passage means extend through the rear face and communicate with the interior cavity inside two adjacent orthogonal sides of the peripheral side wall means. A first, center terminal is mounted on the housing and has a contact portion extending into the interior cavity of the housing and a mounting portion disposed outside the cavity. A second, peripheral terminal has a body portion and a mounting portion extending at an angle to the body portion. The mounting portion and the body portion are inserted into the peripheral passage means spaced outside of the first, center terminal. The second, peripheral terminal includes a spring arm cantilevered from the body portion into the interior cavity of the housing and having a first contact portion thereon. An extension arm is cantilevered from the mounting portion of the peripheral terminal into the interior cavity of the housing and has a second contact portion thereon.

According to one aspect of the invention, a stop wall is disposed at the rear of the interior cavity and defines a recess on the outside of the wall at the rear of the housing. The stop wall has a through hole for receiving the center terminal, with the contact portion of the center terminal extending into the interior cavity of the housing. The center terminal includes an outwardly projecting peripheral collar for abutting the stop wall and defining a stop limit position of insertion of the center terminal into the through hole in the stop wall. A conductive connecting member is disposed in the recess at the rear of the housing for electrically coupling the center terminal to a circuit board. The conductive connecting member includes a plate portion for engaging the center terminal and a foot portion for connection to appropriate circuit means on the circuit board. The plate portion includes an aperture within which the mounting portion of the center terminal is mounted.

According to another aspect of the invention, the spring arm of the peripheral terminal is formed out of an opening in the body portion of the peripheral terminal. The first contact portion is disposed generally at a distal end of the spring arm. The second contact portion is disposed generally at a distal end of the extension arm. The spring arm and the extension arm of the peripheral terminal are cantilevered generally parallel to each other. In the exemplary embodiment, the spring arm and the extension arm are cantilevered in opposite directions relative to each other.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a fragmented perspective view of a cellular phone and power adapter connectible to one power jack of the cellular phone according to the prior art;

FIG. 2 is a fragmented section showing the plug of the power adapter in FIG. 1 inserted into the power jack;

FIG. 3 is an exploded perspective view of a power jack according to the invention;

FIG. 4 is a perspective view of the power jack of FIG. 3, in assembled condition;

FIG. 5 is a perspective view of the power jack, looking at the opposite end of FIG. 4;

FIG. 6 is an elevational view of the powerjack as viewed in FIG. 5;

FIG. 7 is a side elevational view of the power jack as viewed in FIG. 4; and

FIG. 8 is an enlarged perspective view of the second, peripheral terminal of the power jack.

### DETAILED DESCRIPTION OF THE PREFERRED EMBODIMENT

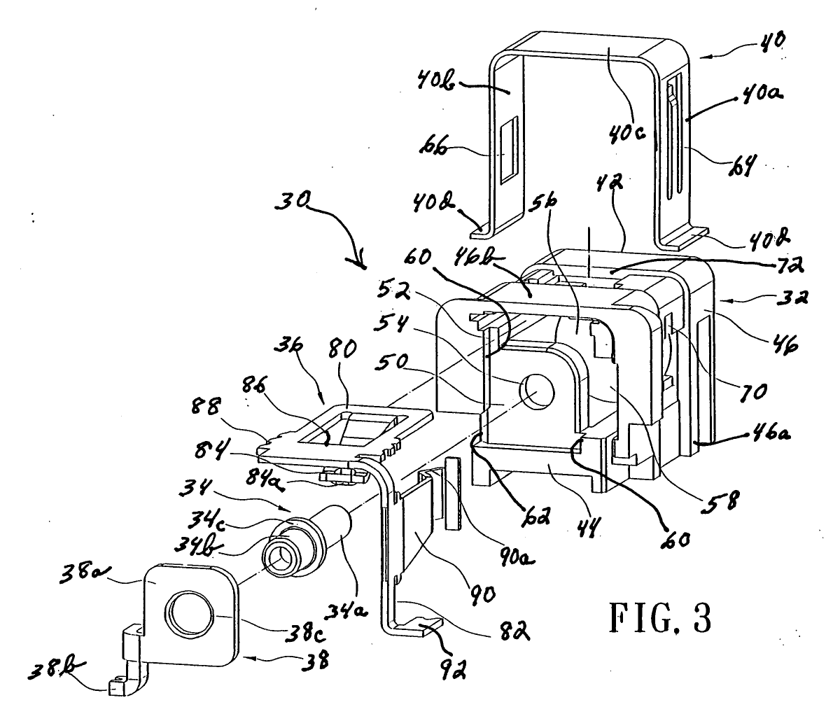

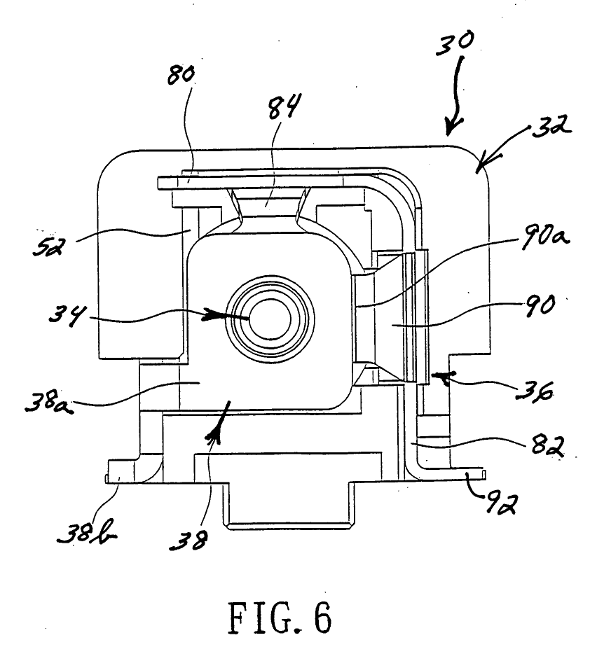

Referring to the drawings in greater detail, and first to FIGS. 3-7, the invention is embodied in a power jack, generally designated 30, which, as best seen in FIG. 3, includes a dielectric or electrically insulative housing, generally designated 32, a first or center terminal, generally designated 34, a second or peripheral terminal, generally designated 36, a conductive connecting member, generally designated 38 and a mounting member, generally designated 40. The entire power jack assembly is adapted for mounting on a printed circuit board (not shown). The jack is adapted for receiving a power adapter (also not shown).

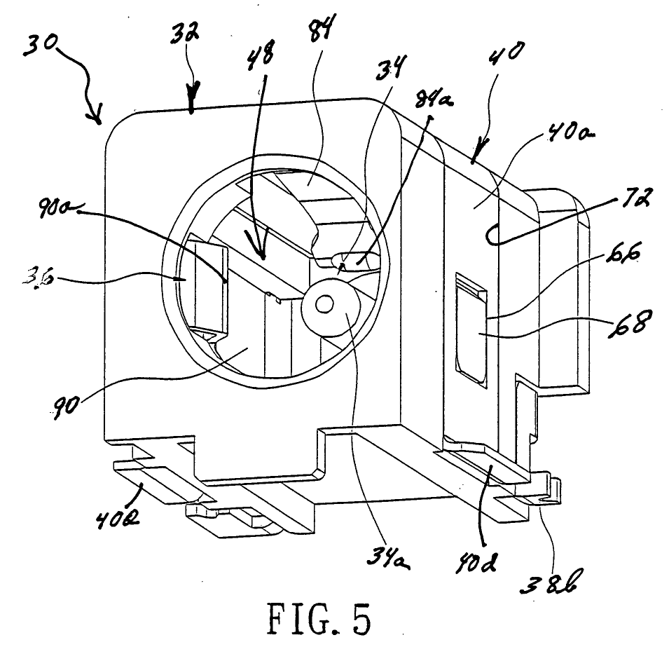

Insulative housing 32 of jack 30 includes a front face 42, a rear face 44 and an orthogonal peripheral side wall means 46 extending between the front and rear faces and forming an interior cavity 48 seen best in FIG. 5. Housing 32 basically is formed in a rectangular box-like configuration with peripheral side wall means 46 including a pair of opposite side walls 46a and a top wall 46b. As best seen in FIG. 3, a stop wall 50 is located at the rear of the interior cavity and defines a recess 52 outside the stop wall at the rear of the housing. A through hole 52 extends through the stop wall. Finally, as also seen best in FIG. 3, peripheral passage means, including a horizontal passage 56 and a vertical passage 58 are formed in rear face 44 of the housing about two adjacent sides of stop wall 50. Horizontal and vertical passages 56 and 58, respectively, communicate with each other and form an L-shaped peripheral passage.

The first or center terminal 34 of jack 30 is generally tubular in configuration and includes an inner contact portion 34a and an outer mounting portion 34b. An outwardly projecting peripheral collar 34c is disposed between the contact and mounting portions of the center terminal. In assembly, inner contact portion 34a of center terminal 34 is inserted into through hole 54 of stop wall 50 until collar 34c abuts the stop wall. When so assembled, contact portion 34a of the center terminal is located within interior cavity 48 as is clearly seen in FIG. 5, while mounting portion 34b of the center terminal projects outwardly of stop wall 50.

Conductive connecting member 38 of jack 30 includes a plate portion 38a and a downwardly extending foot portion 38b as is seen clearly in FIG. 3. A through hole 38c extends through plate portion 38a. In assembly, plate portion 38a of conductive connecting member 38 is positioned within recess 52 at the rear of stop wall 50 of the housing. The plate portion is forced by a press fit between side walls 60 of the recess. The plate portion engages collar 34c of center terminal 34 to hold the center terminal in assembly, while mounting portion 34b of the center terminal projects outwardly through hole 38a of the connecting member. Foot 38b of the connecting member extends through a slot 62 (FIG. 3) of the housing. Foot 38b is provided for connection to an appropriate circuit trace on the printed circuit board.

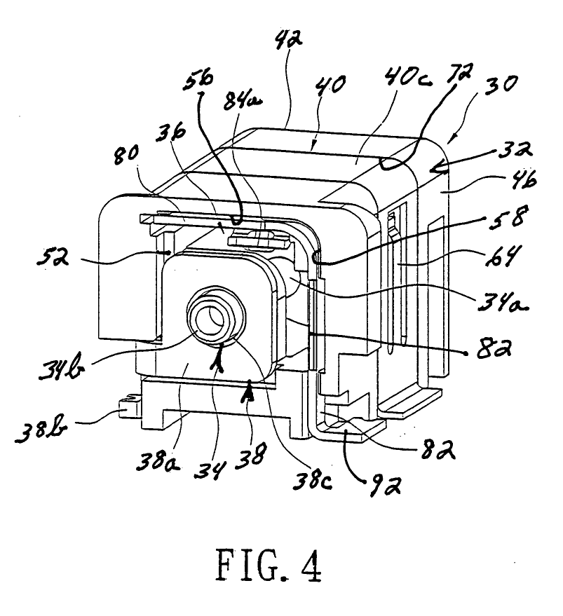

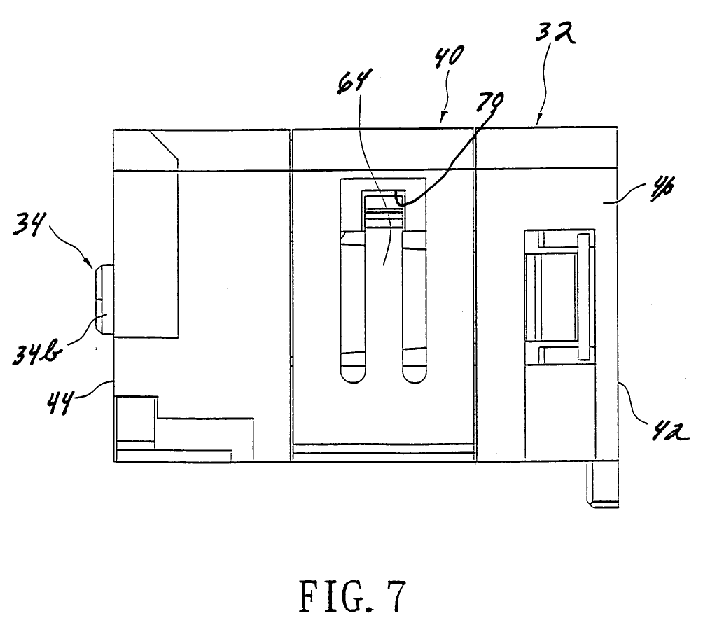

Mounting member 40 of jack 30 may be stamped and formed of metal material in an inverted U-shape to include a pair of leg portions 40a and 40b joined by a bight or cross portion 40c. A pair of mounting flanges 40d project outwardly from the bottom distal ends of legs 40a and 40b. A spring arm 64 is formed out of leg 40a and an aperture 66 is formed in leg 40b of mounting member 40. When the mounting member is moved from its disassembled position of FIG. 3 to its assembled position of FIG. 4, a latch boss 68 snaps into aperture 66 as shown clearly in FIG. 5. Spring arm 64 snaps into a latch hole 70 of the housing as seen in FIG. 7. When the mounting member is fully assembled, it is disposed within a peripheral recess 72 of the peripheral wall means of the housing whereby the mounting member is generally flush with the outside surfaces of the housing as seen clearly in FIGS. 4 and 5. Flanges 40d of the mounting member are secured, as by soldering, to appropriate mounting pads on the printed circuit board to hold powerjack 30 securely on the board.

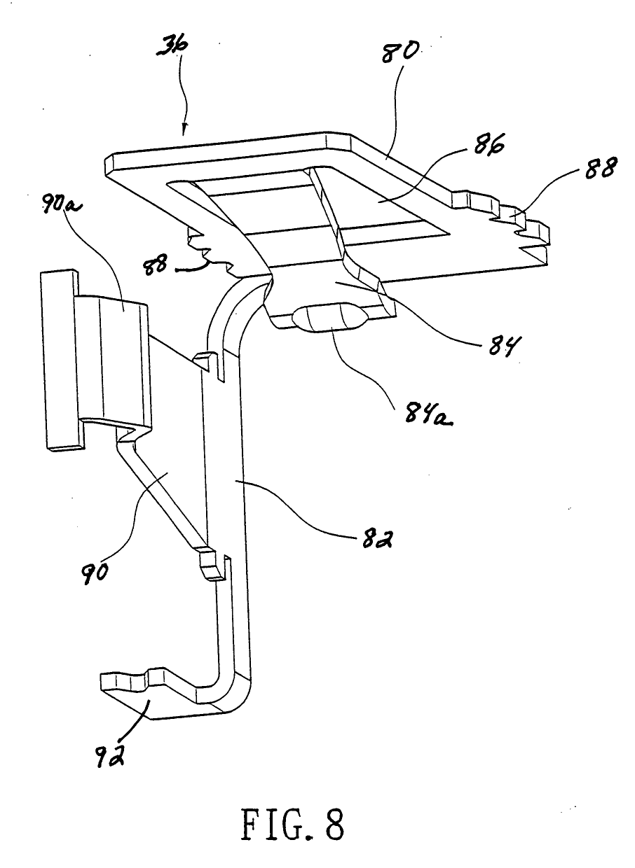

Referring to FIG. 8 in conjunction with FIG. 3, the second or peripheral terminal 36 is generally L-shaped for insertion into the L-shaped peripheral passage means provided by passages 56 and 58 of housing 32. More particularly, peripheral terminal 36 includes a body portion 80 and a mounting portion 82 extending at an angle (i.e., 90°) to the body portion. A spring arm 84 is cantilevered from body portion 80 into interior cavity 48 of the housing as seen best in FIG. 5. The spring arm is stamped and formed out of a hole 86 in body portion 80. An inwardly directed first contact portion 84a is provided at the distal end of cantilevered spring arm 84. The body portion has a plurality of teeth 88 for skiving into the plastic material of the housing within passage 56.

Still referring to FIG. 8 in conjunction with FIG. 3, an extension arm 90 is cantilevered from mounting portion 82 and has a second contact portion 90a at the distal end of the extension arm. As best seen in FIG. 5, like spring arm 84, extension arm 90 also is cantilevered into interior cavity 48 of the housing, with second contact portion 90a disposed within the cavity in an adjacent 90° quadrant from first contact portion 84a of spring arm 84. FIG. 8 shows that spring arm 84 and extension arm 90 are cantilevered generally parallel to each other but in opposite directions. Finally, mounting portion 82 of the peripheral terminal includes a foot portion 92 at the distal end thereof for connection, as by soldering, to an appropriate circuit trace on the printed circuit board.

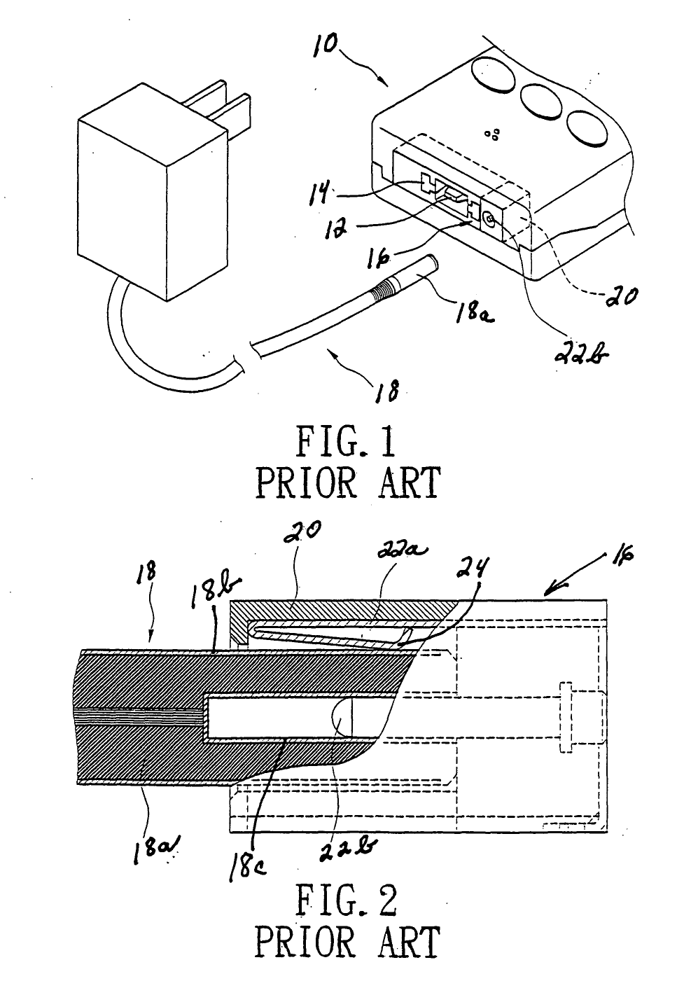

In assembly, it can be seen in FIG. 4 that the L-shaped peripheral terminal 36 is inserted into the L-shaped passage means formed by horizontal passage 56 and vertical passage 58 at the rear of the housing. In essence, body portion 80 of the terminal extends through passage 56 and mounting portion 82 extends through passage 58 so that spring arm 84 and extension arm 90, along with first contact portion 84a and second contact portion 90a are disposed within interior cavity 48 of the housing to provide a very positive, redundant and ensuring connection between peripheral terminal 36 and the contacts of the jack plug inserted into power jack 30, such as the jack plug shown in FIGS. 1 and 2 of the prior art.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A powerjack, comprising:
an insulative housing having a front face, a rear face and peripheral side wall means extending between the front and rear faces and forming an interior cavity within the housing, and peripheral passage means extending through said rear face and communicating with the interior cavity inside two adjacent orthogonal sides of the peripheral side wall means;
a first, center terminal mounted on the housing and having a contact portion extending into the interior cavity of the housing and a mounting portion disposed outside the cavity; and
a second, peripheral terminal having a body portion and a mounting portion extending at an angle to the body portion, the body portion and the mounting portion being inserted into said peripheral passage means spaced outwardly of the first, center terminal, and including
a spring arm cantilevered from said body portion of the second, peripheral terminal into the interior cavity of the housing and having a first contact portion thereon, and
an extension arm cantilevered from said mounting portion of the second, peripheral terminal into the interior cavity of the housing and having a second contact portion thereon.

2. The powerjack of claim 1 wherein said housing includes a stop wall at the rear of said interior cavity and defining a recess on the outside of the wall at the rear of the housing, the stop wall having a through hole for receiving the first, center terminal with the contact portion of the first terminal extending into the interior cavity of the housing.

3. The power jack of claim 2 wherein said first, center terminal includes an outwardly projecting peripheral collar for abutting said stop wall and defining a stop limit position of insertion of the first terminal into the through hole in the stop wall.

4. The power jack of claim 2, including a conductive connecting member disposed in said recess at the rear of the housing for electrically coupling said first, center terminal to a circuit board.

5. The power jack of claim 4 wherein said conductive connecting member includes a plate portion for engaging the first, center terminal and a foot portion for connection to appropriate circuit means on the circuit board.

6. The powerjack of claim 5 wherein the plate portion of said conductive connecting member includes an aperture within which the mounting portion of said first, center terminal is mounted.

7. The power jack of claim 1 wherein said spring arm is formed out of an opening in the body portion of said second, peripheral terminal, said first contact portion being disposed generally at a distal end of the spring arm.

8. The powerjack of claim 1 wherein said second contact portion is disposed generally at a distal end of said extension arm.

9. The power jack of claim 1 wherein the spring arm and the extension arm of said second, peripheral terminal are cantilevered generally parallel to each other.

10. The power jack of claim 1 wherein the spring arm and the extension arm of said second, peripheral terminal are cantilevered in opposite directions relative to each other.

11. A power jack, comprising:
an insulative housing having a front face, a rear face and peripheral side wall means extending between the front and rear faces and forming an interior cavity within the housing, and peripheral passage means extending through said rear face and communicating with the interior cavity inside two adjacent orthogonal sides of the peripheral side wall means;
a first, center terminal mounted on the housing and having a contact portion extending into the interior cavity of the housing and a mounting portion disposed outside the cavity;
a conductive connecting member disposed at the rear of the housing for electrically coupling said first, center terminal to a circuit board;
a second, peripheral terminal having a body portion and a mounting portion extending at an angle to the body portion, the body portion and the mounting portion being inserted into said peripheral passage means spaced outwardly of the first, center terminal, and including
a spring arm formed out of an opening in said body portion of the second, peripheral terminal, the spring arm being cantilevered from the body portion into the interior cavity of the housing and having a first contact portion disposed generally at a distal end of the spring arm, and
an extension arm cantilevered from said mounting portion of the second, peripheral terminal into the interior cavity of the housing and having a second contact portion generally at a distal end of the extension arm, the extension arm being cantilevered generally parallel to said spring arm in the interior cavity of the housing.

12. The power jack of claim 11 wherein said housing includes a stop wall at the rear of said interior cavity generally at the rear of the housing, the stop wall having a through hole for receiving the first, center terminal with the contact portion of the first terminal extending into the interior cavity of the housing.

13. The power jack of claim 12 wherein said first, center terminal includes an outwardly projecting peripheral collar for abutting said stop wall and defining a stop limit position of insertion of the first terminal into the through hole in the stop wall.

14. The power jack of claim 12 wherein a recess is formed on the outside of said stop wall, and said conductive connecting member is disposed in the recess.

15. The power jack of claim 11 wherein said conductive connecting member includes a plate portion for engaging the first, center terminal and a foot portion for connection to appropriate circuit means on the circuit board.

16. The power jack of claim 15 wherein the plate portion of said conductive connecting member includes an aperture within which the mounting portion of said first, center terminal is mounted.

17. The power jack of claim 11 wherein the spring arm and the extension arm of said second, peripheral terminal are cantilevered in opposite directions relative to each other.
